(19) United States
(12) Patent Application Publication
(10) Pub. No.: US 2009/0119131 A1
(43) Pub. Date: May 7, 2009

(54) METHOD FOR CREATING INDIVIDUAL HEALTH RECORDS FROM STANDARD EXPLANATION OF BENEFITS

(75) Inventor: Steven M. Hacker, Delray Beach, FL (US)

Correspondence Address: EDWARDS ANGELL PALMER & DODGE LLP, P.O. BOX 55874, BOSTON, MA, 02205, US

(73) Assignee: PassportMD

(21) Appl. No.: 12/263,988

(22) Filed: Nov. 3, 2008

Related U.S. Application Data
(60) Provisional application No. 60/985,139, filed on Nov. 2, 2007.

(51) Int. Cl. G06Q 40/00; G06Q 50/00

(52) U.S. Cl. 705/3; 705/4

(57) ABSTRACT

A personal health record is maintained by receiving a document having information thereon corresponding to the purchase of healthcare. The document is transmitted to a server by generating an identification code associated with a personal health record stored at the server and affixing it to the transmitted document. The transmitted document is stored as part of the personal health record. Relevant data is extracted from the document and used to populate the personal health record for updating.

### CROSS-REFERENCE TO RELATED APPLICATION

This application claims priority under 35 U.S.C. 119(e) to U.S. Provisional Patent Application No. 60/985,139, filed Nov. 2, 2007.

### BACKGROUND OF THE INVENTION

This invention is directed to a method for monitoring and tracking an individual's healthcare expenses and payments, and more particularly, for building an online health services record for an individual utilizing their explanation of benefit reports.

The cost of healthcare and the complexity of healthcare services, is increasing at a rapid rate in the United States. Those with insurance whether it be governmental (Medicare, Medicaid) or private, find themselves spending more and more time determining which healthcare providers have been paid, which procedures have been covered by insurance, or which need further payment from the individual in the way of a co-pay. The amount of time and activity which must be devoted to monitoring the usage and payment of healthcare for the average individual is becoming greater and greater which only lends itself to abuse and mistake unless monitored carefully.

Furthermore, in order to reduce the amount of unnecessary healthcare services utilized, and to provide some leverage to the patient/consumer, a movement has gained ground to give control of healthcare expenses and overall healthcare management to the consumer. This movement is commonly known as Consumer Directed Healthcare. One of the primary results of this new movement is the development of Health Savings Accounts which provide benefits to healthcare consumers who set aside money to be applied to the healthcare services which they want. However, this makes the tracking of healthcare information and expenses even more critical. As a result of the growing popularity of these health savings accounts, consumers need to track all of their expenses so they may be eligible for reimbursement from their own accounts as well from health insurance providers. Furthermore, tracking a payment from Health Savings Accounts may be required for tax purposes.

However, currently tracking of the disparate types of payments and health services is primarily done manually by the consumer. This is a time consuming process requiring extensive and accurate record keeping, research, filing and data entry primarily based on an Explanation of Benefits report issued by an insurer. For someone who is responsible for an entire household the shortcomings are only compounded. Also because of the manual entry and monitoring of data, the likelihood of error increases as the untrained patient/consumer must normalize the data and conform the data from the varying sources and manually enter it, review it, and confirm its accuracy.

Accordingly, a methodology which overcomes the shortcomings of the prior art is desired.

### BRIEF SUMMARY OF THE INVENTION

A consumer receives an explanation of benefits from the health insurance source. The explanation of benefits report is used as a tool to automatically create individual's online personal health records and is utilized to track online the individual's medical and pharmaceutical expenses without the need for manual data entry. The received explanation of benefits document is digitized and transmitted to a server. The server extracts key data which it utilizes to either create or update a personal health record for the consumer. The extracted information is utilized to confirm the accuracy of healthcare provided, the accuracy of payments due or payments made given a previous payment history (i.e., check for underpayments or overpayments or underbilling or overbilling).

### BRIEF DESCRIPTION OF THE DRAWINGS

FIG. 1 is a schematic diagram of a system for performing the method in accordance with the invention; and

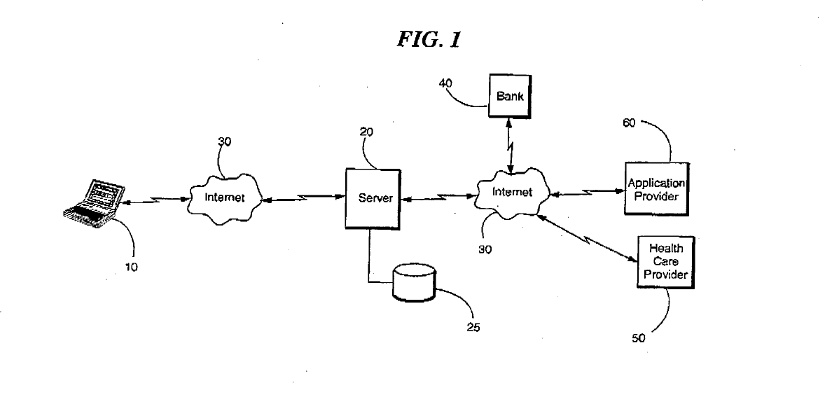

FIG. 2 is a flow chart demonstrating the steps for creating and maintaining a personal health record in accordance with the invention;

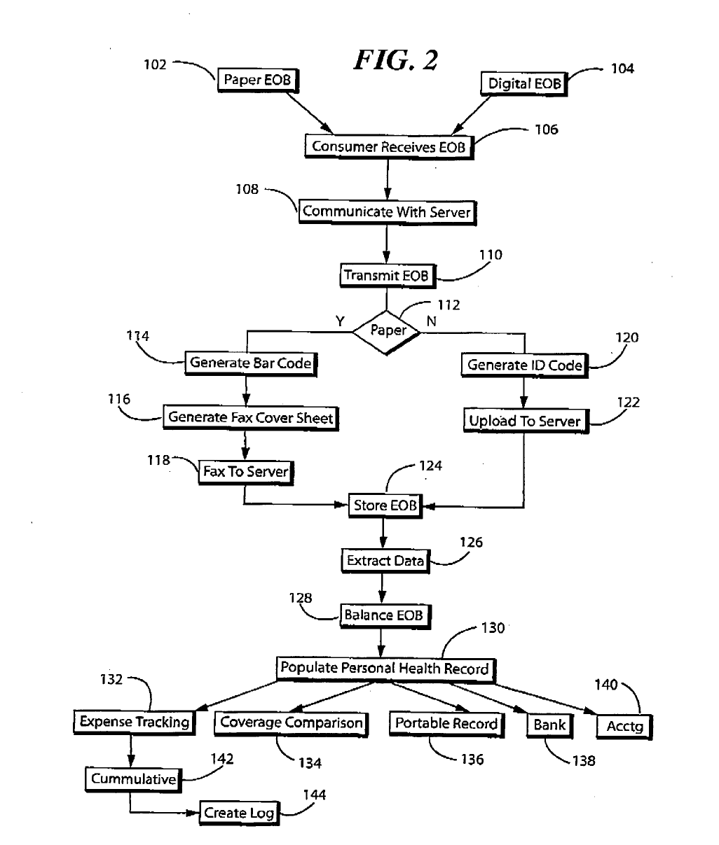

### DETAILED DESCRIPTION OF THE PREFERRED EMBODIMENTS

The present invention is directed to a methodology for creating an online or digital personal health record. The personal health record is the consumer's health history which not only includes a record of health services provided, but the financial characteristics of the delivery of those services. This information will include the nature of the healthcare services delivered whether hospital related, treating physician visit related, for pharmaceutical purchases or the like. The personal health record will also include the financial aspects of the delivery of the healthcare services such as the total amount charged by the treating physician or facility, how much of the charge was covered by insurance, how much of the charge was paid by the consumer, how much was left unpaid or the like. Lastly, it could include digitized copies of the Explanation of Benefits as a back up.

It is assumed for ease of discussion that a consumer personal health record has been established and is associated with a consumer utilizing an identification code. The following description of the invention describes updating the personal health record and using the data stored therein.

As is known in the art, once medical services for which insurance may be applied are provided, the insurance provider transmits an Explanation of Benefits (EOB). The EOB may be transmitted through the regular mails in paper form in a step 102 or digitally e-mailed to the consumer (or downloaded from a website by consumer) in a step 104 to a computer 10 to which a consumer has access.

Computer 10 is in communication with a server 20 across internet 30. A database 25 is associated with server 20 for storing information such as the personal health record of each individual patient/consumer making use of server 20. Server 20 as will be discussed later, may also communicate across internet 30 with third party service providers such as a bank 40, the health care provider 50 or application service providers 60. In step 106 the consumer receives the EOB. The consumer communicates across internet 30 utilizing computer 10 and server 20 in a step 108 and transmits the EOB to server 20 in step 110.

If it is determined in a step 112, that in fact the EOB is in paper form, then in a step 114, server 20 generates a unique barcode. The barcode is a unique identifier which in a preferred embodiment is a function of a consumer identification (pre-assigned) at the creation of a personal health record, and the coverage submission date, but may consist of any information which either identifies the transaction, the consumer or the personal health record. Server 20 then provides a fax number and a cover sheet incorporating the barcode to the consumer in a step 116. The fax cover sheet and EOB document are faxed to server 20 in a step 118. The barcode and fax number may be created by a third party application service provider 60 to server 20. By way of example, Fax.com may provide this service to server 20. Alternatively, the paper document may be scanned at computer 10 and transmitted over internet 30 to server 20.

Similarly, if it is determined that the EOB is in digital form in step 112, a digital identifier is created by server 20 in a step 120 and affixed to the EOB. The document is uploaded to server 20 along with the digital code in a step 122.

In a step 124, server 20 utilizes the associated code to route the image of the Entitlement of Benefit Statement to the appropriate personal health record stored in database 25. In this way, a library of past EOB documents are provided as part of the consumer's personal health record.

At the same time, or in a parallel step 124, pertinent data which may be utilized for processing health care management is extracted from the documents in a step 126. The pertinent data in one embodiment may include patient name and patient address in order to confirm and verify the appropriate personal health record. The extracted data could also include invoice number, date of service, provider name, provider number, insurance provider, the check number utilized to pay for services, place of service may also be extracted Furthermore, insurance information such as procedure code, diagnosis code, procedure units, modifiers, amount billed, patient responsibility, patient co-pay amount, patient deductible amount, amount disallowed, paid amount, balance due if any, message code and plan type user the consumer is enrolled in are all extracted. This extraction may be done by server 20 or by third party software at application service provider 60 such as Concuity's EOB Pro or software loaded onto server 20 such as Any Doc EOB.

Simultaneously with, or in series with steps 124 or 126, in a step 128, the EOB is balanced. In this step server 20 adds up the columns utilizing the extracted data to determine that the appropriate sums such as co-pay and deductible covered expenses have in fact been paid.

In a step 130 which may occur simultaneously with the balancing of the EOB a personal health record file stored in database 25 is revised based on the extracted information.

Once the personal health record has been populated and recreated, then the data contained therein may be utilized in several ways. In a step 132, the data may be exported to a medical expense tracking database either contained within database 25 or at an application service provider 60 to populate a spread sheet database tracking all expenses from the EOB documents by date, provider and costs by way of example. The cost data from the EOB in this step 132 may be used to automatically compare the out-of-pocket expenses paid by a user for a particular service against the reasonable and customary charge for consumers in similar positions as a function of zip code, service and procedure codes.

In a step 134 the cost data may be used to automatically compare the coverage of the consumer's insurance company against other insurance companies offering health care coverage. A report may be generated to determine whether a better plan or coverage may be available.

If the consumer has an HSA or FSA account the cost data and insurance data stored in the personal health record database may be transmitted from server 20 to bank 40 in a step 136 so that the consumer may make use of online banking to not only track their expenses and distributions from their health savings accounts and online checking accounts, but to cause payments from bank 40 to healthcare providers 60.

In a step 138 the cost data extracted from the cost data stored in the personal health record database can be imported into a personal accounting software program such as QUICKEN®, QUICKBOOKS®AND MICROSOFT MONEY® by way of example to automate the expense tracking procedure in a method familiar to most users.

The user in a step 146 accesses their own personal health record utilizing password protected access to printout or download the personal health record onto computer 10 or a portable memory device for personal use.

A cost data analysis may be done in a step 142 utilizing the data from steps 132, 134 or 138 to confirm, similar to the balancing of each individual EOB, whether or not on a cumulative basis the customer is getting the full benefits to which he was entitled to under the health benefit plan. This may include annual individual and family deductibles, annual out-of-pocket maximums for the individual and the family, lifetime maximum payments, coinsurance amounts, the treatment of primary care and gateway physician office visits, specialist visits, x-ray and facility charges, emergency care charges, hospital services inpatient and outpatient, prescription drugs (generic, brand and non-formulary), mail order drugs (generic, brand and non-formulary). In step 144 a log can be generated which logs expenses paid against the entitled coverage to visually represent that the consumer is receiving all of the coverage to which they are entitled.

In some instances, an Explanation of Benefits may not be applicable. For example, not all prescriptions are covered. Additionally, not all medical procedures are covered. In some instances, the consumer may wish to be proactive and not wait for the Explanation of Benefits. A consumer may desire to directly download the charges from the healthcare provider to be used by server 20 as a comparison for the anticipated Explanation of Benefits.

In one exemplary embodiment, in which the healthcare provider 50 is a pharmacy, the consumer will receive a receipt for each transaction. In this embodiment, the paper Explanation of Benefits is replaced by a receipt which may be faxed to server 20 which utilizes an extraction application such as Neat Receipts to extract the eligible healthcare expense data. This data is then exported and processed to the personal health record as discussed above in connection with a paper EOB. Alternatively, the pharmacy could electronically transmit the data from its point of sale records directly to server 20 much like the digital EOB when processing again occurs as discussed above in connection with the EOB.

By automating the process of creating a personal health record and the associated healthcare costs, expenditure and eligibility tracking system a method which reduces the time and susceptibility to errors is provided. By utilizing the Explanation of Benefits report that a consumer already receives from the insurer, and by enabling the consumer to upload the Explanation of Benefits report to a virtual website where the critical data is extracted, the consumer is enabled to automatically update and maintain a personal health record. The data within the personal health record may be utilized to track and compare medical expenses and coverage as well as to pay any outstanding medical bills.

While the preferred embodiments of the invention have been illustrated and described, it will be clear that the invention is not so limited. Numerous modifications, changes, variations, substitutions, equivalents and interchangeable order of steps will occur to those skilled in the art without departing from the spirit and scope of the present invention as described; and set forth in the claims.

What is claimed as new and desired to be protected by Letters Patent of the United States is:

1. A method for maintaining a personal health record comprising the steps of: receiving a document having information thereon corresponding to the purchase of healthcare;
transmitting said document to a server by generating an identification code associated with a personal health record stored at the server and affixing it to the transmitted document;
storing the transmitted document as part of the personal health record;
extracting data from the document and creating a personal health record as a function of said extracted data.

2. The method of claim 1, wherein the document is an Explanation of Benefits.

3. The method of claim 1, wherein said document is a receipt including at least one element corresponding to the delivery of healthcare.

4. The method of claim 1, further comprising the steps of;
determining whether the document as received by the consumer is a paper document; and the server generating a cover sheet, fax number and bar code; incorporating the bar code into the cover sheet; and utilizing the cover sheet and fax number to fax the document to the server.

5. The method of claim 1, further comprising the steps of:
determining whether the received document is a paper document and generating a digital identification code and affixing it to a digital form of the document, if the document is not a paper document and transmitting the digital form of the document with the identification code to the server.

6. The method of claim 1, wherein the server utilizes the personal health record to perform at least one of tracking healthcare expenses, comparing coverage; creating a portable health record; and causing payment for the health services.
